(19) United States
(12) Patent Application Publication
(10) Pub. No.: US 2007/0207248 A1
(43) Pub. Date: Sep. 6, 2007

(54) FOOD COMPOSITIONS

(76) Inventor: Alessandro Seneci, Milano (IT)

Correspondence Address: DYKAS, SHAVER & NIPPER, LLP, P.O. BOX 877, BOISE, ID, 83701-0877, US

(21) Appl. No.: 11/568,586

(22) PCT Filed: May 6, 2005
(86) PCT No.: PCT/IT05/00266

§ 371 Date: Nov. 2, 2006

(30) Foreign Application Priority Data
May 12, 2004 (IT) MI2004A000956

(51) Int. Cl. A23L 1/05

(52) U.S. Cl. 426/573

(57) ABSTRACT

A foodstuff composition is described which contains form 50 to 90% by weight of inulin or fructooligosaccharides, from 10 to 40% by weight of gelling fibres, and from 1 to 10% by weight of water-insoluble fibres. This composition may be mixed with soft wheat flour and/or durum wheat flour and used as an alternative to flour for the preparation of food products for the purpose of reducing the glycaemic peak.

The present invention relates to a novel foodstuff composition capable of reducing the glycaemic, insulinaemic and lipaemic peak after the ingestion of monosaccharides, disaccharides, polysaccharides, lipids and proteins contained therein and contained in the food which may accompany the ingestion thereof; the composition is also capable of introducing soluble fibres having a probiotic effect for the re-balancing and nourishing of bacterial flora. The composition also reduces the glycaemic index of food prepared therewith.

The foodstuff composition according to the present invention is preferably in the form of a powder and can be used in addition to flour for the preparation of food products, such as, for example, bread, baked goods, pasta, biscuits, confectionery, etc.; in particular, approximately 65% by weight of the composition has a granulometry of less than 25 mesh, approximately 20% has a granulometry greater than 25 mesh, approximately 15% has a granulometry greater than 22 mesh, and approximately 1% has a granulometry greater than 19 mesh. The composition according to the present invention contains from 50 to 90% by weight of inulin or fructooligosaccharides, from 10 to 40% by weight of gelling fibres, and from 1 to 10% by weight of water-insoluble fibres, with respect to the total weight of the composition (that is to say, where the sum of the individual components comes to 100).

The gelling fibre is preferably selected from glucomannan, guar gum, karaya gum, psyllium fibre, acacia fibre and/or pectin; the insoluble fibre is preferably selected from wheat fibre, cellulose, hemicellulose and/or lignin, the cellulose preferably being in microcrystalline form.

According to a first preferred aspect of the invention, the composition contains from 60 to 80% by weight of inulin or fructooligosaccharides, preferably from 65 to 75% by weight, and even more preferably approximately 70% by weight. According to a second preferred aspect of the invention, the composition contains from 15 to 35% by weight of gelling fibres, preferably from 20 to 30% by weight, and even more preferably approximately 25% by weight.

According to a third preferred aspect of the invention, the composition contains from 3 to 7% by weight of insoluble fibre, preferably from 4 to 6% by weight, and even more preferably approximately 5% by weight.

It should be emphasized that all of the fibres that can be used for the invention, that is to say, soluble and insoluble fibres, may be used as such or in their naturally occurring non-purified form. For example, inulin may be used in the form of chicory fibre, pectin in the form of apple and/or orange fibre, and cellulose in the form of wheat and/or oat fibre, etc.

According to the preferred aspect of the invention, the foodstuff composition is constituted by 70% by weight of inulin, 5% by weight of glucomannan, 20% by weight of guar gum and 5% by weight of wheat fibre.

As mentioned above, the foodstuff composition according to the present invention can be used in admixture with soft wheat flour and/or durum wheat flour for the preparation of food products, such as, for example, bread, baked goods, pasta, biscuits, confectionery, etc.

For that purpose, 2-8 parts by weight of foodstuff composition can be mixed with 40-60 parts by weight of soft wheat flour and/or durum wheat flour; according to a preferred aspect, 4-6 parts by weight of composition, preferably 4.5-5.5, and even more preferably approximately 5, are mixed with 44-56, preferably 48-52, and even more preferably approximately 50 parts by weight of flour.

For the purposes of the present invention, the percentages are to be understood as percentages by weight with respect to the total weight of the composition. According to a preferred aspect, the composition according to the present invention comprises inulin and/or fructooligosaccharides, gelling fibres and water-insoluble fibres in the ratios by weight indicated above.

### EXPERIMENTAL SECTION

A foodstuff composition according to the present invention (hereinafter indicated by the term “brake”), and having the qualitative-quantitative composition indicated hereinafter was used to evaluate the reduction in the glycaemic peak resulting from the consumption of biscuits with respect to a reference standard:
inulin: 70% by weight;
glucomannan: 5% by weight;
guar gum: 20% by weight;
wheat fibre: 5% by weight.

The composition of the “braked” biscuits, that is to say, containing the “brake” according to the present invention, is shown hereinafter together with that of the comparison biscuits not containing any “brake”.

| | | | Quantity | Quantity |
|---|---|---|---|---|
| | % by | | normal | “braked” |
| grams | weight | Product | biscuit | biscuit |
| 5800 | 54.00 | Soft wheat flour + 13.5% | 2900 | 2510 |
| | | of brake by gross weight | | 390 |
| 2200 | 20.50 | Butter | 1200 | 1200 |
| 2000 | 18.60 | Caster sugar | 1000 | 1000 |
| 360 | 3.40 | Large whole eggs (No. 3) | 178 | 180 |
| 370 | 3.50 | Egg yolks | 182 | 182 |
| 2 | 0.02 | Vanilla flavouring | 1 | 1 |
| 4 | 0.04 | Lemon flavouring | 2 | 2 |
| Total | 100.06 | Yield - 15% after baking | 5463 | 5465 |
| | | in a fan oven at 210° C. for | 4300 | 4900 |
| | | 13 minutes | | |

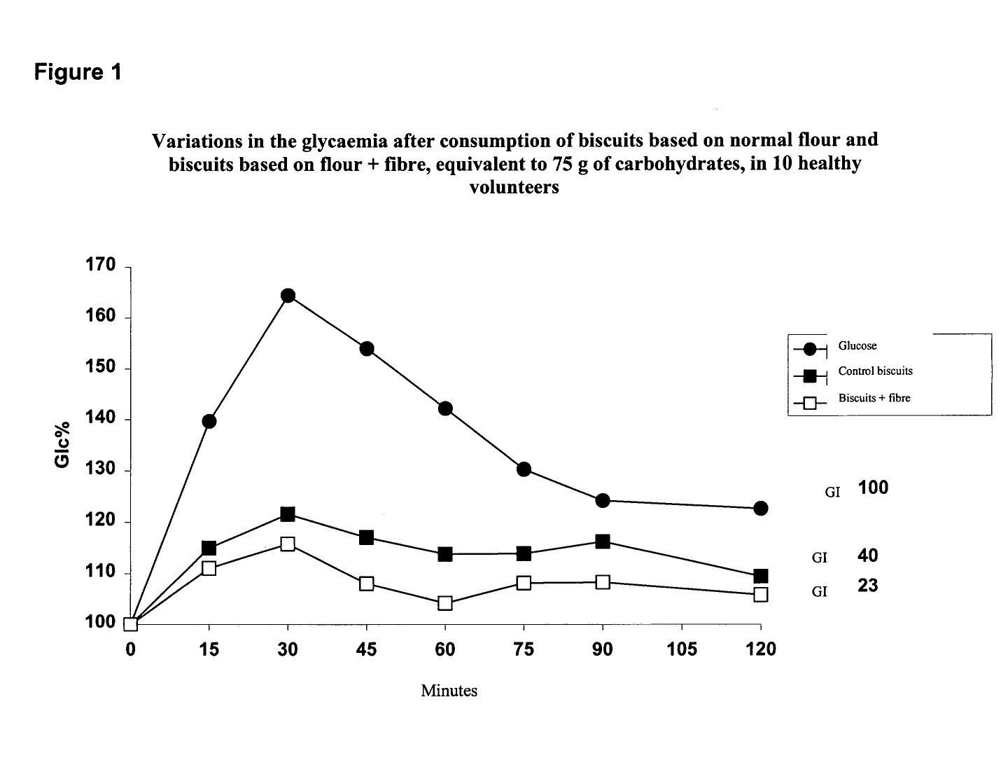

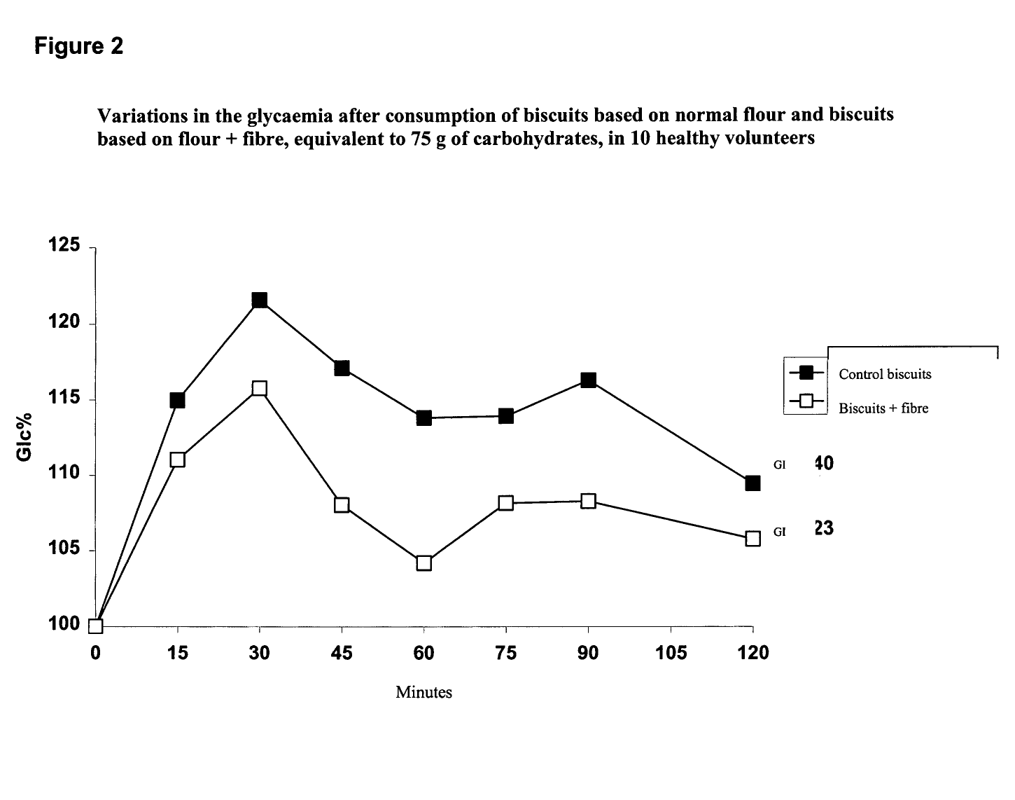

The “braked” biscuits and the control biscuits not containing any “brake”, were administered to 10 healthy volunteers whose glycaemic levels were measured compared with a reference standard based on pure glucose. The results are shown in FIGS. 1 and 2. (where the “braked” biscuit is indicated as “biscuit+fibre”). FIG. 1, in particular, shows the glycaemic levels compared with the reference standard; FIG. 2 on the other hand shows only the glycaemic levels resulting from the consumption of the biscuits. As will be readily appreciated, the presence in the biscuits of the composition according to the invention permits a reduction in the glycaemic index of 42.5% in the “braked” biscuit compared with the normal biscuit.

1. A foodstuff composition containing from 50 to 90% by weight of inulin or fructooligosaccharides, from 10 to 40% by weight of gelling fibres, and from 1 to 10% by weight of water-insoluble fibres, with respect to the total weight of the composition.

2. A foodstuff composition according to claim 1, characterized in that the gelling fibre is selected from glucomannan, guar gum, karaya gum, psyllium fibre, acacia fibre and/or pectin.

3. A foodstuff composition according to claim 1, characterized in that the insoluble fibre is selected from wheat fibre, cellulose, hemi-cellulose and/or lignin.

4. A foodstuff composition according to claim 3, characterized in that the cellulose is in microcrystalline form.

5. A foodstuff composition according to any one of the preceding claims, characterized in that it contains from 60 to 80% by weight of inulin or fructooligosaccharides.

6. A foodstuff composition according to any one of the preceding claims, characterized in that it contains from 65 to 75% by weight of inulin or fructooligosaccharides.

7. A foodstuff composition according to any one of the preceding claims, characterized in that it contains approximately 70% by weight of inulin or fructooligosaccharides.

8. A foodstuff composition according to any one of the preceding claims, characterized in that it contains from 15 to 35% by weight of gelling fibres.

9. A foodstuff composition according to any one of the preceding claims, characterized in that it contains from 20 to 30% by weight of gelling fibres.

10. A foodstuff composition according to any one of the preceding claims, characterized in that it contains approximately 25% by weight of gelling fibres.

11. A foodstuff composition according to any one of the preceding claims, characterized in that it contains from 3 to 7% by weight of insoluble fibres.

12. A foodstuff composition according to any one of the preceding claims, characterized in that it contains from 4 to 6% by weight of insoluble fibres.

13. A foodstuff composition according to any one of the preceding claims, characterized in that it contains approximately 5% by weight of insoluble fibres.

14. A foodstuff composition according to any one of the preceding claims, characterized in that it contains approximately 70% by weight of inulin, approximately 5% by weight of glucomannan, approximately 20% by weight of guar gum and approximately 5% by weight of wheat fibre.

15. A foodstuff composition containing 2-8 parts by weight, preferably 4-6, of a composition according to claims 1-14, and 40-60 parts by weight, preferably 44-56, of soft wheat flour and/or durum wheat flour.

16. A foodstuff composition containing 4.5-5.5 parts by weight, preferably approximately 5, of a composition according to claims 1-14, and 48-52 parts by weight, preferably approximately 50, of soft wheat flour and/or durum wheat flour.

17. Food products containing a foodstuff composition according to claims 1-16.

18. Food products according to claim 17, selected from bread, baked goods, pasta, biscuits, confectionery.

19. Use of a foodstuff composition according to claims 1-16 for the preparation of food products.

20. Use of a foodstuff composition or a food product according to any one of the preceding claims for the reduction of the glycaemic, insulinaemic and/or lipaemic peak caused by the consumption of monosaccharides, disaccharides, polysaccharides, lipids and/or proteins.
